(19) United States
(12) Patent Application Publication
(10) Pub. No.: US 2014/0181761 A1
(43) Pub. Date: Jun. 26, 2014

(54) IDENTIFYING CIRCUIT ELEMENTS FOR SELECTIVE INCLUSION IN SPEED-PUSH PROCESSING IN AN INTEGRATED CIRCUIT, AND RELATED CIRCUIT SYSTEMS, APPARATUS, AND COMPUTER-READABLE MEDIA

(71) Applicant: QUALCOMM INCORPORATED, San Diego, CA (US)

(72) Inventors: Jeffrey H. Fischer, Raleigh, NC (US); William R. Flederbach, Holly Springs, NC (US); Kyungseok Kim, Cary, NC (US); Robert J. Bucki, Raleigh, NC (US); Chock H. Gan, Raleigh, NC (US); William J. Goodall, III, Cary, NC (US)

(73) Assignee: QUALCOMM Incorporated, San Diego, CA (US)

(21) Appl. No.: 13/723,919

(22) Filed: Dec. 21, 2012

(51) Int. Cl. G06F 17/50

(52) U.S. Cl. CPC G06F 17/50
USPC 716/52; 716/51

(57) ABSTRACT

Embodiments of the disclosure include identifying circuit elements for selective inclusion in speed-push processing and related circuit systems, apparatus, and computer-readable media. A method for altering a speed-push mask is provided, including analyzing a circuit design comprising a plurality of cells to which a speed-push mask is applied to identify at least one of the plurality of cells as having performance margin. The speed-push mask is altered such that the at least one of the plurality of cells having performance margin may be fabricated as a non-speed-pushed cell. Additionally, a method for creating a speed-push mask is provided, including analyzing a circuit design comprising a plurality of cells to identify at least one of the plurality of cells below a performance threshold. A speed-push mask is created such that the at least one of the plurality of cells below the performance threshold may be fabricated as a speed-pushed cell.

### RELATED APPLICATION

The present application is related to co-pending U.S. patent application Ser. No. 13/372,160, filed on Feb. 13, 2012 and entitled “Method and Apparatus to Enable a Selective Push Process During Manufacturing to Improve Performance of a Selected Circuit of an Integrated Circuit,” which is hereby incorporated herein by reference in its entirety.

### BACKGROUND

I. Field of the Disclosure

The technology of the disclosure relates generally to enhancing speed and power characteristics of an integrated circuit.

II. Background

Improving performance capabilities of integrated circuits, in terms of both speed and power consumption, is becoming an increasingly important concern with respect to a wide variety of applications, particularly mobile systems-on-a-chip (SOCs). Conventionally, an integrated circuit is designed using transistor models simulated at certain voltages and temperatures. This ensures that the circuit design meets performance criteria with respect to signal processing speed and power consumption and leakage. The integrated circuit is then manufactured according to transistor specifications defined by the circuit design. While this conventional approach ensures the integrated circuit will satisfy the desired performance criteria, any modifications to improve the performance of the integrated circuit may require a redesign of the entire integrated circuit, potentially incurring high engineering costs and long development cycle times.

A number of techniques have been developed for implementing performance-enhancing modifications to various devices making up the integrated circuit without necessitating a complete redesign of the circuit. These modifications, which may have the effect of reducing circuit delays, are collectively referred to as “speed-push modifications” or “speed-pushing.” The circuits or devices resulting from such modifications are typically said to be “speed-pushed.” Some non-limiting examples of speed-push modifications are changing transistor threshold voltages, manipulating channel width and length, and thinning gate oxides, among other techniques. The extent to which a device may be speed-pushed depends in large part on a “performance margin” of the device. “Performance margin” is an excess performance capacity of the device above a certain specified minimum performance capability. A conventional method of applying speed-pushing to all devices in a core of the integrated circuit speeds up all of the devices in the core equally. This method has been conventionally employed to boost the performance of the core while simultaneously utilizing a lower power technology. Unfortunately, this approach also results in greatly increased power leakage of the core.

Thus, it is desirable to improve performance of an integrated circuit without causing excessive power leakage through use of speed-pushing techniques.

### SUMMARY OF THE DISCLOSURE

Embodiments of the disclosure provide identifying circuit elements for selective inclusion in speed-push processing in an integrated circuit. Related circuit systems, apparatus, and computer-readable media are also disclosed. In this regard, in one embodiment, a method for altering a speed-push mask is provided. The method comprises analyzing a circuit design comprising a plurality of cells to which a speed-push mask is applied. The method further comprises identifying at least one of the plurality of cells as having performance margin based on analyzing the circuit design. The method additionally comprises altering the speed-push mask to indicate that the at least one of the plurality of cells having performance margin is to be fabricated as a non-speed-pushed cell. In this manner, power leakage that may result from fabricating cells containing non-critical paths of an integrated circuit as speed-pushed cells may be avoided.

In another embodiment, a speed-push mask processing circuit is provided. The speed-push mask processing circuit is configured to analyze a circuit design comprising a plurality of cells to which a speed-push mask is applied. The speed-push mask processing circuit is additionally configured to identify at least one of the plurality of cells as having performance margin based on analyzing the circuit design. The speed-push mask processing circuit is further configured to alter the speed-push mask to indicate that the at least one of the plurality of cells having performance margin is to be fabricated as a non-speed-pushed cell.

In a further embodiment, a speed-push mask processing circuit is provided. The speed-push mask processing circuit comprises a means for analyzing a circuit design comprising a plurality of cells to which a speed-push mask is applied. The speed-push mask processing circuit further comprises a means for identifying at least one of the plurality of cells as having performance margin based on analyzing the circuit design. The speed-push mask processing circuit also comprises a means for altering the speed-push mask to indicate that the at least one of the plurality of cells having performance margin is to be fabricated as a non-speed-pushed cell.

In an additional embodiment, a non-transitory computer-readable medium is provided, having stored thereon computer-executable instructions to cause a processor to implement a method for analyzing a circuit design comprising a plurality of cells to which a speed-push mask is applied. The method implemented by the computer-executable instructions further comprises identifying at least one of the plurality of cells as having performance margin based on analyzing the circuit design. The method implemented by the computer-executable instructions additionally comprises altering the speed-push mask to indicate that the at least one of the plurality of cells having performance margin is to be fabricated as a non-speed-pushed cell.

In another embodiment, a method for creating a speed-push mask is provided. The method comprises analyzing a circuit design comprising a plurality of cells is analyzed, and identifying at least one of the plurality of cells below a performance threshold based on analyzing the circuit design. The method further comprises creating a speed-push mask indicating that the at least one of the plurality of cells below the performance threshold is to be fabricated as a speed-pushed cell. In this manner, performance enhancements may be realized by fabricating cells containing critical paths of an integrated circuit as speed-pushed cells.

In a further embodiment, a speed-push mask processing circuit is provided. The speed-push mask processing circuit is configured to analyze a circuit design comprising a plurality of cells, and is additionally configured to identify at least one of the plurality of cells below a performance threshold based on analyzing the circuit design. The speed-push mask processing circuit is also configured to create a speed-push mask indicating that the at least one of the plurality of cells below the performance threshold is to be fabricated as a speed-pushed cell.

In an additional embodiment, a speed-push mask processing circuit is provided. The speed-push mask processing circuit comprises a means for analyzing a circuit design comprising a plurality of cells. The speed-push mask processing circuit further comprises a means for identifying at least one of the plurality of cells below a performance threshold based on analyzing the circuit design. The speed-push mask processing circuit also comprises a means for creating a speed-push mask indicating that the at least one of the plurality of cells below the performance threshold is to be fabricated as a speed-pushed cell.

In another embodiment, a non-transitory computer-readable medium is provided, having stored thereon computer-executable instructions to cause a processor to implement a method for analyzing a circuit design comprising a plurality of cells. The method implemented by the computer-executable instructions further comprises identifying at least one of the plurality of cells below a performance threshold based on analyzing the circuit design. The method implemented by the computer-executable instructions additionally comprises creating a speed-push mask indicating that the at least one of the plurality of cells below the performance threshold is to be fabricated as a speed-pushed cell.

### BRIEF DESCRIPTION OF THE FIGURES

FIG. 1 is a block diagram of an exemplary circuit illustrating various sample signal paths impacted by selective speed-push flow;

FIG. 2 is a flowchart of an exemplary process for altering a speed-push mask to apply a selective speed-push flow in a circuit design, such as the circuit in FIG. 1;

FIG. 3 is a flowchart of an exemplary process for determining which of a plurality of cells in a circuit design, such as the circuit in FIG. 1, have performance margin;

FIG. 4 is a flowchart of an exemplary process for creating a speed-push mask by identifying cells for speed-push fabrication in a circuit design, such as the circuit in FIG. 1;

FIG. 5 is a flowchart of an exemplary process for determining which of a plurality of cells in a circuit design, such as the circuit in FIG. 1, is below a performance threshold;

FIG. 6 illustrates exemplary scenarios in which minimum area violations in a speed-push mask in a circuit design, such as the circuit in FIG. 1, may be identified and corrected; and

FIG. 7 is a block diagram of an exemplary processor-based system that can include the circuit of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments of the disclosure provide identifying circuit elements for selective inclusion in speed-push processing in an integrated circuit. Related circuit systems, apparatus, and computer-readable media are also disclosed. In this regard, in one embodiment, a method for altering a speed-push mask is provided. The method comprises analyzing a circuit design comprising a plurality of cells to which a speed-push mask is applied. The method further comprises identifying at least one of the plurality of cells as having performance margin based on analyzing the circuit design. The method additionally comprises altering the speed-push mask to indicate that the at least one of the plurality of cells having performance margin is to be fabricated as a non-speed-pushed cell. In this manner, power leakage that may result from fabricating cells containing non-critical paths of an integrated circuit as speed-pushed cells may be avoided.

In another embodiment, a method for creating a speed-push mask is provided. The method comprises analyzing a circuit design comprising a plurality of cells is analyzed, and identifying at least one of the plurality of cells below a performance threshold based on analyzing the circuit design. The method further comprises creating a speed-push mask indicating that the at least one of the plurality of cells below the performance threshold is to be fabricated as a speed-pushed cell. In this way, performance enhancements may be realized by fabricating cells containing critical paths of an integrated circuit as speed-pushed cells.

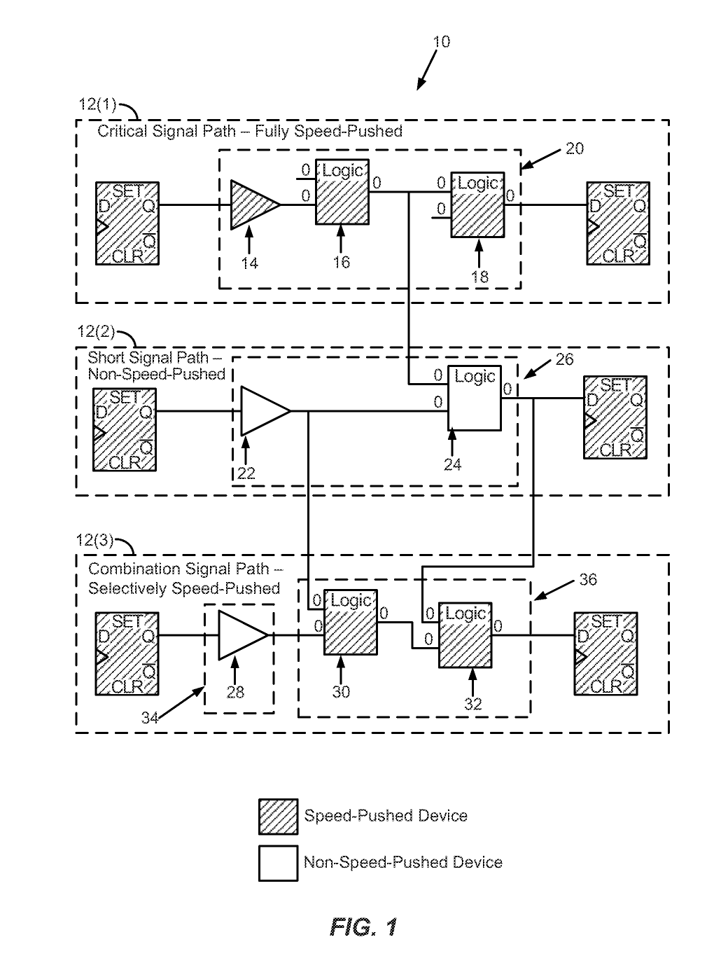

In this regard, FIG. 1 is a block diagram of an exemplary circuit 10 illustrating various sample signal paths 12 impacted by selective speed-push flow according to embodiments discussed herein. As noted above, selective speed-pushing may avoid excessive power leakage by enabling cells containing non-critical paths of an integrated circuit to be fabricated as non-speed-pushed cells, while also boosting circuit performance by fabricating cells containing critical paths as speed-pushed cells. For example, in FIG. 1, the circuit 10 comprises three signal paths 12(1)-12(3). The signal path 12(1) connects a first flip-flop to a second flip-flop, and includes a buffer 14 and first and second logic gates 16, 18. The signal path 12(1) has been identified as a path that limits a signal processing speed of the entire circuit 10, and, thus, the overall efficiency of the circuit 10. Accordingly, this signal path 12(1) is designated as a “critical path.” To provide the maximum performance boost for the circuit 10, all devices in the signal path 12(1) are speed-pushed in this example, as indicated by speed-pushed path 20.

In contrast, the signal path 12(2), comprising a buffer 22 and a logic gate 24, is a “short signal path” that has been identified as non-critical. A non-critical signal path is a signal path that does not limit the signal processing speed of the circuit 10. Thus, operating the signal path 12(2) at a performance level in excess of the required performance specifications of its constituent components does not improve the overall performance of the circuit 10. Indeed, operating the signal path 12(2) at a performance level in excess of the required performance specifications may contribute to excessive power leakage of the circuit 10. Accordingly, the buffer 22 and the logic gate 24 constituting the signal path 12(2) may be said to have performance margin. In order to conserve power with minimal impact on the overall performance of the circuit 10, speed-pushing is not implemented for the signal path 12(2), as indicated by non-speed-pushed path 26.

The signal path 12(3) illustrates a “combination signal path” comprised of a selective mixture of speed-pushed and non-speed-pushed devices. The signal path 12(3) begins and ends with a first and second flip-flop, respectively, and includes a buffer 28 and first and second logic gates 30, 32. In the signal path 12(3), the buffer 28 has been identified as having performance margin. However, the first and second logic gates 30, 32 have been determined to be below a performance threshold (e.g., a speed threshold, a power threshold, or both). Accordingly, to minimize power leakage and maximize performance, the buffer 28 is not speed-pushed, while both the first and second logic gates 30, 32 are speed-pushed. This is illustrated in non-speed-pushed path 34 and speed-pushed path 36 in FIG. 1.

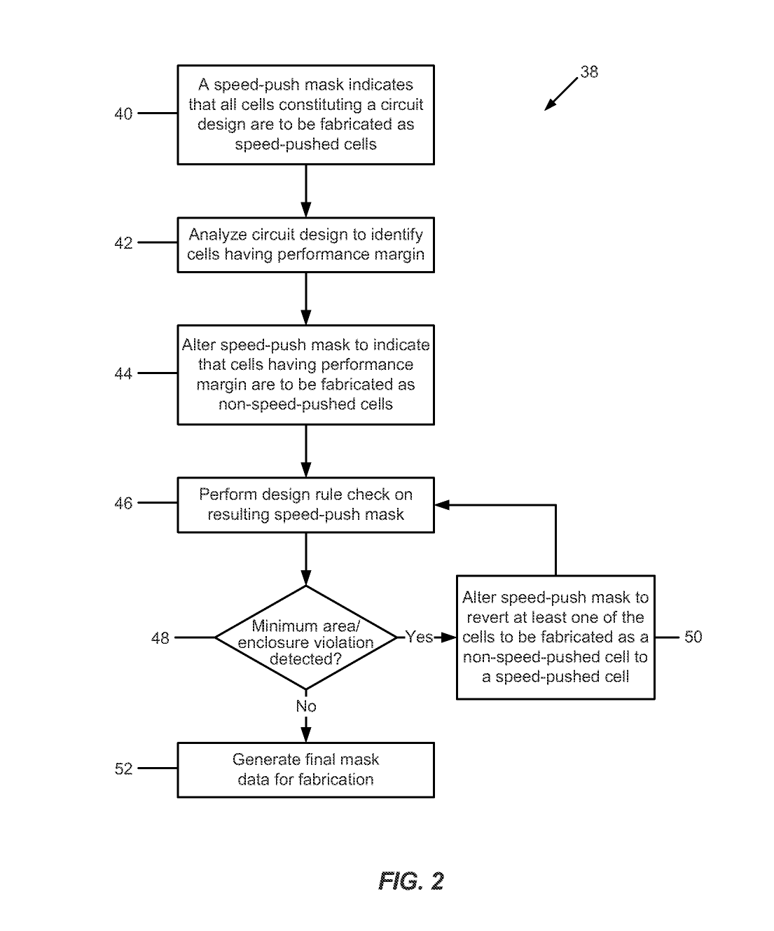

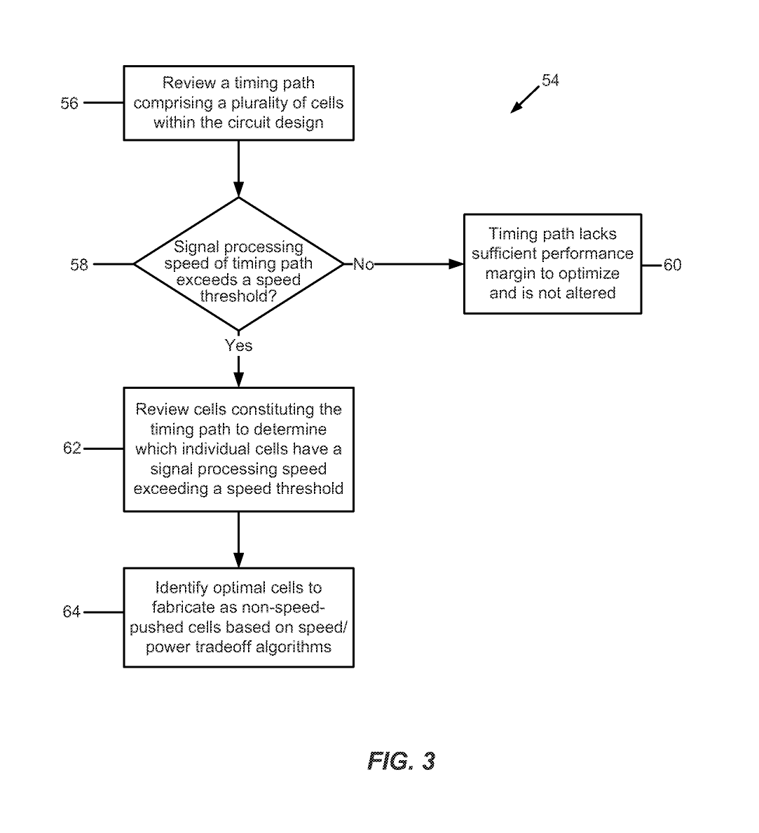

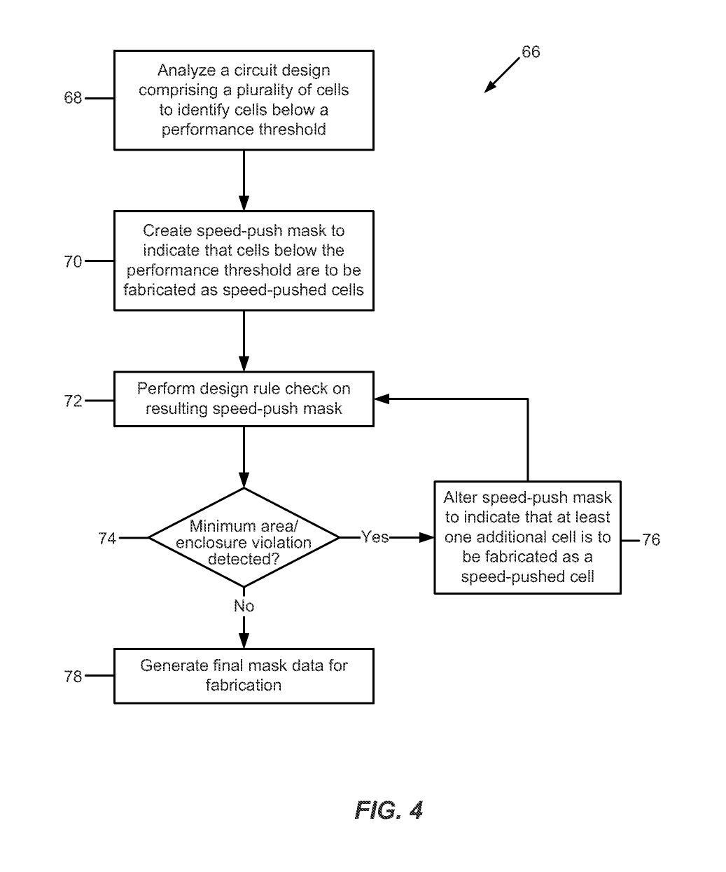

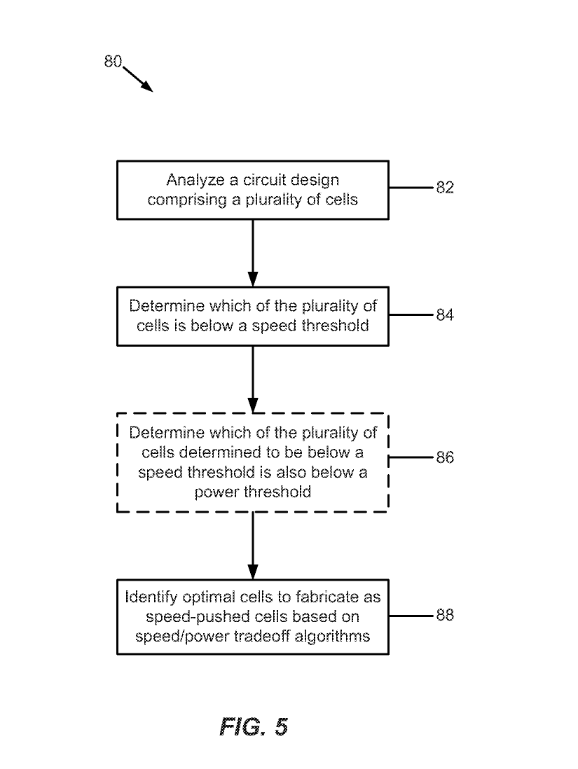

In some embodiments, the signal path 12(3) may be produced wherein the buffer 28 and the first and second logic gates 30, 32 are initially designated as speed-pushed by a speed-push mask. The buffer 28 is subsequently determined to have performance margin, and the cell containing the buffer 28 in the circuit design is removed from the speed-push mask and fabricated as a non-speed-pushed cell. This example is discussed in greater detail below with respect to FIGS. 2-3. In other embodiments, the signal path 12(3) may be produced wherein the buffer 28 and the first and second logic gates 30, 32 are not initially designated as speed-pushed. The first and second logic gates 30, 32 are subsequently determined to be below a performance threshold, and cells containing the first and second logic gates 30, 32 are added to a speed-push mask and fabricated as speed-pushed cells. This exemplary scenario is discussed in more detail below with respect to FIGS. 4-5.

As used herein, a “cell” refers to a circuit design element representing physical devices or structures for providing Boolean logic functions or storage functions in a circuit. Circuits are conventionally designed by selecting and assembling cells from commonly available cell libraries. As noted above, in some embodiments, power leakage of an integrated circuit may be reduced without sacrificing circuit performance by selectively including cells in a speed-push mask to avoid fabrication of cells containing non-critical paths of the integrated circuit as speed-pushed cells.

In this regard, FIG. 2 is a flowchart illustrating an exemplary process 38 for altering a speed-push mask to apply a selective speed-push flow in a circuit design, such as the circuit 10 depicted in FIG. 1. The process 38 begins with a circuit design (for example, a design of a processor core circuitry) for which a speed-push mask indicates that a plurality of cells constituting the circuit design are to be fabricated as speed-pushed cells (block 40). The circuit design is analyzed to determine which of the cells to which the speed-push mask is applied have performance margin (e.g., “timing slack,” a condition in which signal processing speed of a cell may be reduced without affecting the overall signal processing speed of the circuit) (block 42). An exemplary process by which this analysis may be performed is discussed in greater detail below with respect to FIG. 3. The cells determined to have performance margin may be designated as non-speed-pushed devices by altering the speed-push mask to indicate that the cells having performance margin may be fabricated as non-speed-pushed cells (block 44). In some embodiments, for example, an opening may be made in the speed-push mask corresponding to physical dimensions of the cell.

A process typically referred to as a design rule check is then performed on the resulting speed-push mask (block 46). Generally, when fabricating an integrated circuit, a size of a speed-push mask feature is inversely proportional to the likelihood that an underlying circuit may be physically manufactured to desired specifications. Stated differently, the smaller the area of the speed-push mask feature, the less likely that successful fabrication may be guaranteed. Thus, fabrication facilities specify design rules that dictate minimum permissible areas for mask enclosure regions. Requiring that a speed-push mask adhere to these minimum area/enclosure rules may help to garner a lower probability of fabrication defects.

The results of the design rule check are reviewed to determine if a minimum area/enclosure violation was detected within the speed-push mask (block 48). For example, a minimum area/enclosure violation may comprise an area of the speed-push mask, representing a speed-pushed or non-speed-pushed cell, which violates the minimum area/enclosure rule. If the speed-push mask is found to have minimum area and/or enclosure violations, then the speed-push mask is altered to resolve the minimum area and/or enclosure violations (block 50). Resolving the minimum area and/or enclosure violations in this manner may involve fabricating at least one additional cell as a non-speed-pushed cell or reverting at least one of the cells to be fabricated as a non-speed-pushed cell to a speed-pushed cell depending on power and performance targets. The design rule check is then repeated in order to detect any remaining minimum area/enclosure violations within the speed-push mask (block 46). If no minimum area and/or enclosure violations are detected, then the altered speed-push mask is used to generate final mask data for fabrication (block 52).

As referenced above with respect to block 42 of FIG. 2, an exemplary process 54 for determining which of a plurality of cells in a circuit design have performance margin is illustrated in FIG. 3. The process 54 described in this example in FIG. 3 may be based on, for example, a database containing information regarding speed-pushed logic blocks and associated timing constraints, signal processing speed, and/or power consumption. In this regard, a timing path comprising a plurality of cells in the circuit design, to which the speed-push mask is to be applied, is first reviewed (block 56). A determination is made regarding whether the signal processing speed of the timing path as a whole exceeds a designed or desired speed threshold (i.e., has “timing slack”) (block 58). If the signal processing speed of the timing path does not exceed the designed or desired speed threshold, an insufficient performance margin exists to optimize the timing path, and the timing path is not altered in the speed-push mask (block 60). If the signal processing speed of the timing path exceeds the designed or desired speed threshold, individual cells within the timing path are reviewed to determine which cells have performance margin, insofar as an individual cell's signal processing speed exceeds a speed threshold (block 62). Based on the review of the individual devices' performance margin and known algorithms for determining speed/power tradeoffs, the optimal cells to designate as non-speed-pushed cells in the speed-push mask are selected (block 64).

In some embodiments, performance of an integrated circuit may be enhanced by fabricating cells that are below a performance threshold as speed-pushed cells. For example, the performance threshold may comprise speed threshold, a power threshold, or a combination of both. In this regard, FIG. 4 is a flowchart of an exemplary process 66 for creating a speed-push mask by identifying cells for selective inclusion in speed-push fabrication in a circuit design, such as the circuit 10 depicted in FIG. 1, as a non-limiting example. The process 66 begins with an analysis of a circuit design comprising a plurality of cells to identify cells below a performance threshold (block 68). The circuit design may comprise, for example, a design of a processor core circuitry. An exemplary process by which this analysis may be performed is discussed below in greater detail with respect to FIG. 5. Referring back to FIG. 4, a speed-push mask is created, indicating that the cells below the performance threshold are to be fabricated as speed-pushed cells (block 70).

A design rule check is then performed on the resulting speed-push mask (block 72). As noted above with respect to the exemplary process 38 in FIG. 2, a design rule check ensures that a speed-push mask adheres to design rules that may help to ensure a lower probability of fabrication defects. The results of the design rule check are reviewed to determine whether a minimum area/enclosure violation was detected within the speed-push mask (i.e., whether any feature of the speed-push mask indicating that an underlying cell is to be fabricated as a speed-pushed cell violates the minimum area/enclosure rule) (block 74). If the speed-push mask is found to have minimum area and/or enclosure violations, then the speed-push mask is altered to resolve the minimum area and/or enclosure violations (block 76). Resolving the minimum area and/or enclosure violations in this manner may involve fabricating at least one additional cell as a speed-pushed cell or reverting at least one of the cells to be fabricated as a speed-pushed cell to a non-speed-pushed cell depending on power and performance targets. The design rule check is then repeated in order to detect any remaining minimum area/enclosure violations within the speed-push mask (block 72). If no minimum area and/or enclosure violations are detected at block 74, then the speed-push mask is used to generate final mask data for fabrication (block 78).

An exemplary process 80 for determining which of a plurality of cells in a circuit design are below a performance threshold, as discussed with respect to block 68 of FIG. 4, is illustrated in FIG. 5. The process 80 may be based on a database containing information regarding speed-pushed logic blocks and associated timing constraints, signal processing speed, and/or power consumption, as examples. A circuit design comprising a plurality of cells is first analyzed (block 82). A determination is made regarding which of the plurality of cells operates at a signal processing speed below a speed threshold (block 84). Optionally, a determination may also be made regarding which of the plurality of cells determined to be below the speed threshold also operates at a power level below a power threshold (block 86). Based on these determinations and known algorithms for determining speed/power tradeoffs, optimal cells to designate as speed-pushed cells in the speed-push mask are identified (block 88). This data is then utilized in the operations for creating the speed-push mask in block 70 of FIG. 4.

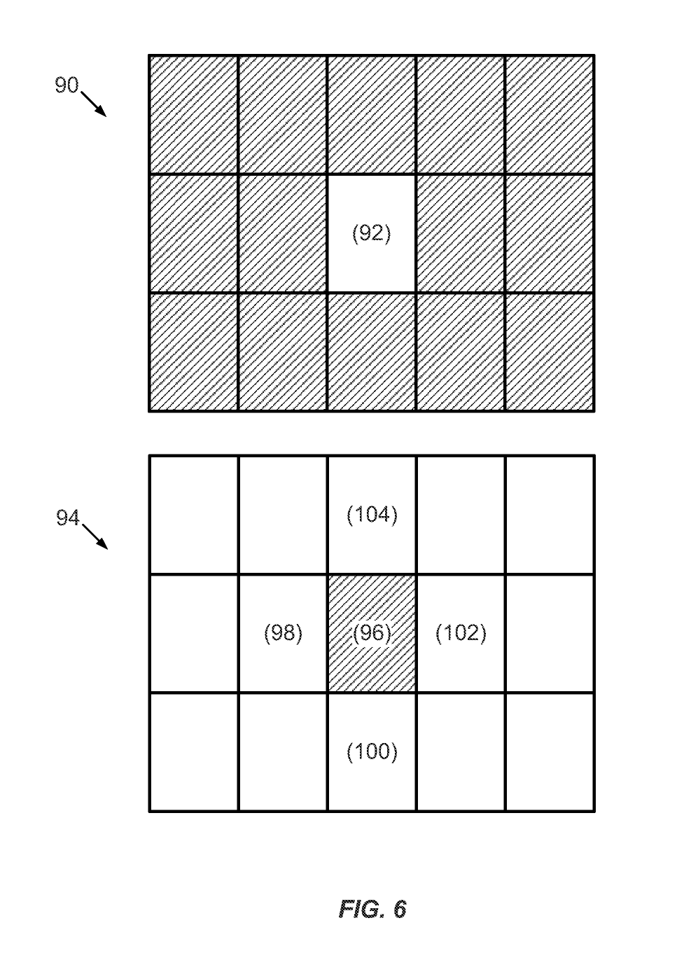

As noted above with respect to decision block 48 in FIG. 2 and decision block 74 in FIG. 4, some embodiments may provide that a design rule check is carried out in which a speed-push mask is examined for compliance with minimum area/enclosure rules. In this regard, FIG. 6 shows two exemplary scenarios in which minimum area/enclosure violations may be identified and corrected. Assume for the example in FIG. 6 that a minimum area/enclosure rule requires the minimum area for features of the illustrated speed-push mask to be two square units (due to, for instance, the fabrication process being capable of reliably manufacturing only circuit elements having an area of two square units or larger). In speed-push mask 90, all cells, with the exception of a cell 92, have been designated as speed-pushed. However, because the cell 92 has an area less than the minimum allowable area of two square units, a minimum area/enclosure violation is detected during a design rule check. To resolve this minimum area/enclosure violation while maintaining the speed-pushed status of the other cells, the speed-push mask 90 may be altered to revert the cell 92 back to a speed-pushed cell. Alternatively, a cell adjacent to cell 92 may be fabricated as a non-speed-pushed cell, depending on performance and power targets.

A speed-push mask 94, in which only a cell 96 is designated as speed-pushed, illustrates the converse scenario. Because the cell 96 has an area less than the two-square-unit minimum allowable area, the cell 96 represents a minimum area/enclosure violation. In this case, to resolve the minimum area/enclosure violation while maintaining the speed-pushed status of the cell 96, the speed-push mask 94 may be modified to also designate one of adjacent cells 98, 100, 102, or 104 as a speed-pushed cell. Alternatively, the cell 96 may be fabricated as a non-speed-pushed cell, depending on performance and power targets. Those having skill in the art will recognize that resolutions described for these two scenarios are presented only as examples, and will be readily able to devise other resolutions to these two scenarios that are consistent with the inventive concepts described herein.

Identifying circuit elements for selective inclusion in speed-push processing in an integrated circuit, and related circuit systems, apparatus, and computer-readable media, according to embodiments disclosed herein, may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

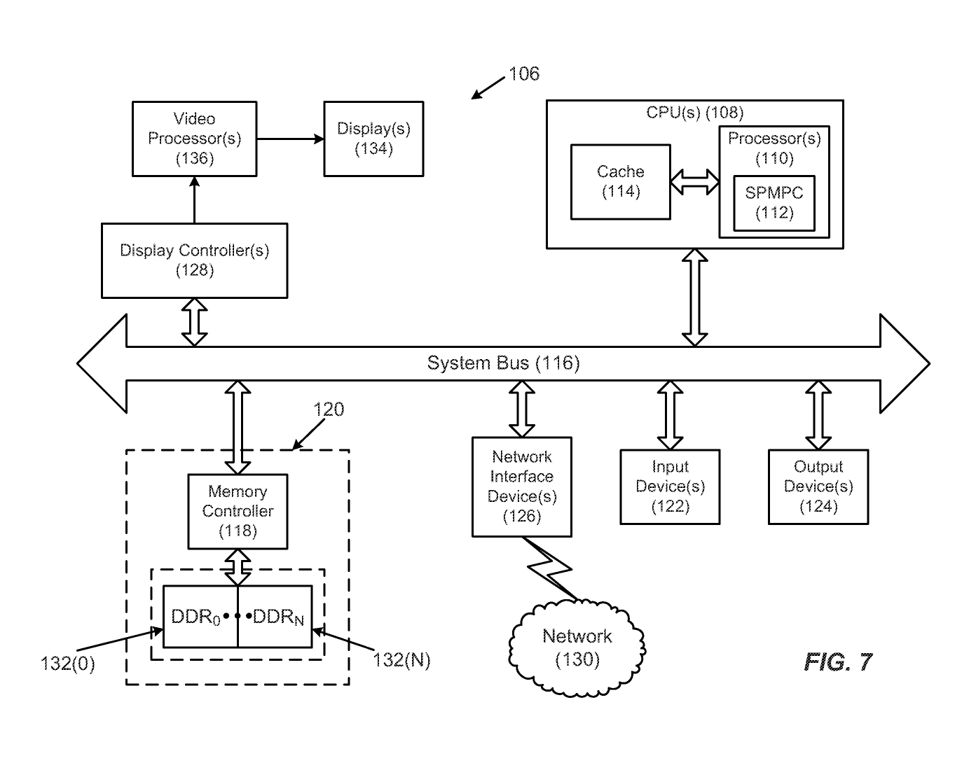

In this regard, FIG. 7 illustrates an example of a processor-based system 106 that may implement a speed-push mask processing circuit as recited herein. In this example, the processor-based system 106 includes one or more central processing units (CPUs) 108, each including one or more processors 110. The processor(s) 110 may comprise a speed-push mask processing circuit (SPMPC) 112. The CPU(s) 108 may be a master device. The CPU(s) 108 may have cache memory 114 coupled to the processor(s) 110 for rapid access to temporarily stored data. The CPU(s) 108 is coupled to a system bus 116 and can intercouple master and slave devices included in the processor-based system 106. As is well known, the CPU(s) 108 communicates with these other devices by exchanging address, control, and data information over the system bus 116. For example, the CPU(s) 108 can communicate bus transaction requests to a memory controller 118, as an example of a slave device.

Other master and slave devices can be connected to the system bus 116. As illustrated in FIG. 7, these devices can include a memory system 120, one or more input devices 122, one or more output devices 124, one or more network interface devices 126, and one or more display controllers 128, as examples. The input device(s) 122 can include any type of input device, including but not limited to input keys, switches, voice processors, etc. The output device(s) 124 can include any type of output device, including but not limited to audio, video, other visual indicators, etc. The network interface device(s) 126 can be any devices configured to allow exchange of data to and from a network 130. The network 130 can be any type of network, including but not limited to a wired or wireless network, a private or public network, a local area network (LAN), a wide local area network (WLAN), and the Internet. The network interface device(s) 126 can be configured to support any type of communication protocol desired. The memory system 120 can include one or more memory units 132(0-N).

The CPU(s) 108 may also be configured to access the display controller(s) 128 over the system bus 116 to control information sent to one or more displays 134. The display controller(s) 128 sends information to the display(s) 134 to be displayed via one or more video processors 136, which process the information to be displayed into a format suitable for the display(s) 134. The display(s) 134 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

1. A method for altering a speed-push mask, comprising:
analyzing, by a processor, a circuit design comprising a plurality of cells to which a speed-push mask is applied;
identifying, by the processor, at least one of the plurality of cells as having performance margin based on analyzing the circuit design; and
altering, by the processor, the speed-push mask to indicate that the at least one of the plurality of cells having performance margin is to be fabricated as a non-speed-pushed cell by modifying at least one of a channel width, a channel length, or a gate oxide thickness of the non-speed-pushed cell.

2. The method of claim 1, further comprising:
performing a design rule check on the speed-push mask;
identifying a minimum area/enclosure violation within the speed-push mask based on the design rule check; and
resolving the minimum area/enclosure violation.

3. The method of claim 2, wherein resolving the minimum area/enclosure violation comprises altering the speed-push mask to revert at least one cell to be fabricated as a non-speed-pushed cell to a speed-pushed cell.

4. The method of claim 2, wherein resolving the minimum area/enclosure violation comprises altering the speed-push mask to indicate that at least one additional cell is to be fabricated as a speed-pushed cell.

5. The method of claim 1, wherein identifying the at least one of the plurality of cells having performance margin comprises determining that a signal processing speed of the at least one of the plurality of cells exceeds a speed threshold.

6. A speed-push mask processing circuit configured to:
analyze a circuit design comprising a plurality of cells to which a speed-push mask is applied;
identify at least one of the plurality of cells as having performance margin based on analyzing the circuit design; and
alter the speed-push mask to indicate that the at least one of the plurality of cells having performance margin is to be fabricated as a non-speed-pushed cell by modifying at least one of a channel width, a channel length, or a rate oxide thickness of the non-speed-pushed cell.

7. The speed-push mask processing circuit of claim 6, further configured to:
perform a design rule check on the speed-push mask;
identify a minimum area/enclosure violation within the speed-push mask based on the design rule check; and
resolve the minimum area/enclosure violation.

8. The speed-push mask processing circuit of claim 7, configured to resolve the minimum area/enclosure violation by altering the speed-push mask to revert at least one cell to be fabricated as a non-speed-pushed cell to a speed-pushed cell.

9. The speed-push mask processing circuit of claim 7, configured to resolve the minimum area/enclosure violation by altering the speed-push mask to indicate that at least one additional cell is to be fabricated as a speed-pushed cell.

10. The speed-push mask processing circuit of claim 6 integrated into a semiconductor die.

11. The speed-push mask processing circuit of claim 6, further comprising a device selected from the group consisting of: a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player in which the speed-push mask processing circuit is included.

12. A speed-push mask processing circuit, comprising:
a means for analyzing a circuit design comprising a plurality of cells to which a speed-push mask is applied;
a means for identifying at least one of the plurality of cells as having performance margin based on analyzing the circuit design; and
a means for altering the speed-push mask to indicate that the at least one of the plurality of cells having performance margin is to be fabricated as a non-speed-pushed cell by modifying at least one of a channel width, a channel length, or a gate oxide thickness of the non-speed-pushed cell.

13. A non-transitory computer-readable medium, having stored thereon computer-executable instructions to cause a processor to implement a method comprising:
analyzing a circuit design comprising a plurality of cells to which a speed-push mask is applied;
identifying at least one of the plurality of cells as having performance margin based on analyzing the circuit design; and
altering the speed-push mask to indicate that the at least one of the plurality of cells having performance margin is to be fabricated as a non-speed-pushed cell by modifying at least one of a channel width, a channel length, or a gate oxide thickness of the non-speed-pushed cell.

14. The non-transitory computer-readable medium of claim 13, having stored thereon the computer-executable instructions to cause the processor to implement the method further comprising:
performing a design rule check on the speed-push mask;
identifying a minimum area/enclosure violation within the speed-push mask based on the design rule check; and
resolving the minimum area/enclosure violation.

15. The non-transitory computer-readable medium of claim 14, having stored thereon the computer-executable instructions to cause the processor to implement the method wherein resolving the minimum area/enclosure violation comprises altering the speed-push mask to revert at least one cell to be fabricated as a non-speed-pushed cell to a speed-pushed cell.

16. The non-transitory computer-readable medium of claim 14, having stored thereon the computer-executable instructions to cause the processor to implement the method wherein resolving the minimum area/enclosure violation comprises altering the speed-push mask to indicate that at least one additional cell is to be fabricated as a speed-pushed cell.

17. A method for creating a speed-push mask, comprising:
analyzing, by a processor, a circuit design comprising a plurality of cells;
identifying, by the processor, at least one of the plurality of cells below a performance threshold based on analyzing the circuit design; and
creating, by the processor, a speed-push mask indicating that the at least one of the plurality of cells below the performance threshold is to be fabricated as a speed-pushed cell by modifying at least one of a channel width, a channel length, or a gate oxide thickness, of the speed-pushed cell.

18. The method of claim 17, further comprising:
performing a design rule check on the speed-push mask;
identifying a minimum area/enclosure violation within the speed-push mask based on the design rule check; and
resolving the minimum area/enclosure violation.

19. The method of claim 18, wherein resolving the minimum area/enclosure violation comprises altering the speed-push mask to indicate that at least one additional cell is to be fabricated as a speed-pushed cell.

20. The method of claim 18, wherein resolving the minimum area/enclosure violation comprises altering the speed-push mask to revert at least one cell to be fabricated as a non-speed-pushed cell to a speed-pushed cell.

21. The method of claim 17, wherein identifying the at least one of the plurality of cells below the performance threshold comprises determining that a signal processing speed of the at least one of the plurality of cells is below a speed threshold.

22. The method of claim 17, wherein identifying the at least one of the plurality of cells below the performance threshold comprises determining that a power level at which the at least one of the plurality of cells operates is below a power threshold.

23. A speed-push mask processing circuit configured to:
analyze a circuit design comprising a plurality of cells;
identify at least one of the plurality of cells below a performance threshold based on analyzing the circuit design; and
create a speed-push mask indicating that the at least one of the plurality of cells below the performance threshold is to be fabricated as a speed-pushed cell by modifying at least one of a channel width, a channel length, or a gate oxide thickness of the seed-pushed cell.

24. The speed-push mask processing circuit of claim 23, further configured to:
perform a design rule check on the speed-push mask;
identify a minimum area/enclosure violation within the speed-push mask based on the design rule check; and
resolve the minimum area/enclosure violation.

25. The speed-push mask processing circuit of claim 24, configured to resolve the minimum area/enclosure violation by altering the speed-push mask to indicate that at least one additional cell is to be fabricated as a speed-pushed cell.

26. The speed-push mask processing circuit of claim 24, configured to resolve the minimum area/enclosure violation by altering the speed-push mask to revert at least one cell to be fabricated as a non-speed-pushed cell to a speed-pushed cell.

27. The speed-push mask processing circuit of claim 23 integrated into a semiconductor die.

28. The speed-push mask processing circuit of claim 23, further comprising a device selected from the group consisting of: a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player in which the speed-push mask processing circuit is included.

29. A speed-push mask processing circuit, comprising:
a means for analyzing a circuit design comprising a plurality of cells;
a means for identifying at least one of the plurality of cells below a performance threshold based on analyzing the circuit design; and
a means for creating a speed-push mask indicating that the at least one of the plurality of cells below the performance threshold is to be fabricated as a speed-pushed cell by modifying at least one of a channel width, a channel length, or a gate oxide thickness of the seed-pushed cell.

30. A non-transitory computer-readable medium, having stored thereon computer-executable instructions to cause a processor to implement a method comprising:
analyzing a circuit design comprising a plurality of cells;
identifying at least one of the plurality of cells below a performance threshold based on analyzing the circuit design; and
creating a speed-push mask indicating that the at least one of the plurality of cells below the performance threshold is to be fabricated as a speed-pushed cell by modifying at least one of a channel width, a channel length, or a gate oxide thickness of the speed-pushed cell.

31. The non-transitory computer-readable medium of claim 30, having stored thereon the computer-executable instructions to cause the processor to implement the method further comprising:
performing a design rule check on the speed-push mask;
identifying a minimum area/enclosure violation within the speed-push mask based on the design rule check; and
resolving the minimum area/enclosure violation.

32. The non-transitory computer-readable medium of claim 31, having stored thereon the computer-executable instructions to cause the processor to implement the method wherein resolving the minimum area/enclosure violation comprises altering the speed-push mask to indicate that at least one additional cell is to be fabricated as a speed-pushed cell.

33. The non-transitory computer-readable medium of claim 31, having stored thereon the computer-executable instructions to cause the processor to implement the method wherein resolving the minimum area/enclosure violation comprises altering the speed-push mask to revert at least one cell to be fabricated as a non-speed-pushed cell to a speed-pushed cell.
